(19) United States
(12) Patent Application Publication
(10) Pub. No.: US 2010/0181182 A1
(43) Pub. Date: Jul. 22, 2010

(54) BREAKER WITH A GAS DRIVE FOR LOW-VOLTAGE, MEDIUM-VOLTAGE AND HIGH-VOLTAGE SWITCHING DEVICES

(75) Inventors: Dietmar GENTSCH, Ratingen (DE); Harald Fink, Ratingen (DE)

Correspondence Address: BUCHANAN, INGERSOLL & ROONEY PC, POST OFFICE BOX 1404, ALEXANDRIA, VA, 22313-1404, US

(73) Assignee: ABB TECHNOLOGY AG, Zurich (CH)

(21) Appl. No.: 12/689,725

(22) Filed: Jan. 19, 2010

Related U.S. Application Data
(63) Continuation of application No. PCT/EP2007/006455, filed on Jul. 20, 2007.

(51) Int. Cl. H01H 35/38

(52) U.S. Cl. 200/82 R

(57) ABSTRACT

An exemplary breaker is disclosed with a gas drive for low-voltage, medium-voltage and high-voltage switching devices, in which disconnection can be generated via detonation capsules. To ensure that a low number of connection and disconnection operations in relation to the total operating duration of the circuit breaker is taken into consideration in design terms, without in the process reducing safety, exemplary embodiments include a piston/cylinder arrangement with a plurality of detonation capsules for generating a limited number of connection and disconnection operations in the cylinder in each of the two cylinder subareas which are separated by the piston.

### RELATED APPLICATIONS

This application claims priority as a continuation application under 35 U.S.C. §120 to PCT/EP2007/006455 filed as an International Application on Jul. 20, 2007 designating the U.S., the entire content of which is hereby incorporated by reference in its entirety.

### FIELD

The disclosure relates to circuit breakers such as breakers with a gas drive for low-voltage, medium-voltage and high-voltage switching devices, in which disconnection can be generated via detonation capsules.

### BACKGROUND INFORMATION

Connection and disconnection of contact pieces can take place virtually exclusively by mechanical, hydraulic or electromagnetic switching devices. The switching energy can be stored mechanically (e.g., spring tensioning), or electrically. Furthermore, manual switching can be used in known switching devices.

For example, spring drives or spring energy store drives can be based on a purely mechanical principle, in which mechanical energy storage takes place in a prestressed spring, such as a tension spring or a compression spring, in a torsion spring or hydraulically.

Electromagnetic drives are based on a part-mechanical principle, namely the storage of electrical energy for example by capacitors.

### SUMMARY

A circuit breaker is disclosed with a gas breaker drive for switching devices; and a piston/cylinder arrangement operated by a detonation capsule for disconnection at the breaker drive, wherein the piston/cylinder arrangement includes a plurality of detonation capsules for generating a limited number of connection and disconnection operations in the cylinder in each of two cylinder subareas separated by the piston.

### BRIEF DESCRIPTION OF THE DRAWINGS

An exemplary embodiment is illustrated in the drawing and will be described in more detail below.

FIG. 1 shows an exemplary vacuum interrupter chamber with a bellows, which is connected to an explosive breaker piston via a drive rod.

### DETAILED DESCRIPTION

An exemplary circuit breaker is disclosed wherein a low number of connection and disconnection operations based on the total operating duration of the circuit breaker can be taken into consideration in design terms, without safety being reduced.

An exemplary piston/cylinder arrangement is provided with a plurality of detonation capsules for generating a limited number of connection and disconnection operations in the cylinder in each of the two cylinder subareas which can be separated by the piston. That is to say the piston can be operated in corresponding fashion from both sides in order to thus bring about a fast connection and, in the same way, to bring about a fast shutdown of the circuit breaker only in the reverse direction of actuation.

In an exemplary case, an intentionally limited number of detonation capsules or propellant charges can take account of only few connection and disconnection operations being requested throughout the life of the circuit breaker. The functional elements, which are disposed so to speak as emergency switching means, can therefore be realized in simple and compact form.

An exemplary advantageous configuration involves detonation capsules which each contain an electrically or mechanically ignitable explosive charge. By this means, a pressure can be given very quickly and very effectively onto the respective actuation side of the piston of the mentioned piston/cylinder arrangement in order to actuate the circuit breaker.

As an exemplary alternative to this, the detonation capsules may also be designed such that they contain a compressed pressure medium, which is released in the form of an explosion and acts on the corresponding piston side of the circuit breaker drive.

In an exemplary case, the pressure medium can be released suddenly (e.g., almost immediately) from the detonation capsule via a controllable valve. Even when using pressure medium instead of an explosive charge or a propellant, there can be therefore no or very little delay; at least, for example, no notable delay.

To achieve rapid control, this alternative can be designed such that the closure of the detonation capsule can be opened suddenly if desired by an electrically or mechanically controllable microexplosive charge.

An exemplary advantageous configuration involves a breaker specified as a vacuum chamber breaker. This breaker type can be advantageously suitable in connection with the described drive.

A further exemplary advantageous configuration involves a breaker specified as a single-phase breaker or as a multiple arrangement in the form of a polyphase breaker arrangement.

A further exemplary advantageous configuration involves pressure control valves arranged in a region of the cylinder of a piston/cylinder arrangement which is applied with the detonation capsules, which pressure control valves deventilate so as to relieve pressure in the event of a pressure above a desired actuation pressure. This can prevent the pressure generation from being destructive, but at the same time can ensure that the pressure for the switching operation is also built up. For example, above this limit pressure, the pressure relief devices triggered.

There is a plurality of advantageous alternatives to this, such as a pressure valve, or a sintered material element, or a flow resistance element being used for pressure relief.

A further exemplary advantageous configuration involves, in addition to the described switching mode, a manually operable lever mechanism provided in redundant fashion, via which shutdown can likewise be carried out.

In order to hold end (e.g., connection/disconnection) positions reached in each case (representing, for example, on or off positions of the contact elements), provision can be advantageously made for the contact elements to be held in these positions by, for example, permanent magnets.

A further exemplary advantageous configuration involves features, such as the piston/cylinder arrangement together with the vacuum interrupter chamber, being embedded in a common thermosetting-plastic encapsulation. Naturally other plastic or rubber encapsulations can be used including, for example, polyamide or similar materials in injection-molding technology.

An exemplary advantageous configuration involves a circuit breaker which includes, on each of both sides, one female connector for direct connection in a cable run.

Another exemplary advantageous configuration involves a circuit breaker provided, at least on one connection side, with a high-speed grounding system.

A drive system, and a further possible application of a circuit breaker in electrical systems are therefore disclosed. Known systems available today can remain unchanged apart from exemplary features disclosed herein. In particular, however, physical size can, for example, be markedly reduced for a circuit breaker disclosed herein.

Furthermore, with known circuit breakers, numbers of make/break operations of a few ten thousand switching operations can be implemented. Exemplary embodiments disclosed herein can be suitable for widespread application with breakers which implement a limited number of switching operations. Another advantage of exemplary breakers disclosed herein is the fact that this system can be used in a cable section (e.g., without the need for the use of a circuit breaker in combination with a switchgear assembly).

A structurally small circuit breaker with a limited number of mechanical switching operations which are carried out under short-circuit, load or rated-current conditions therefore results.

As disclosed herein, a compact breaker can, for example, be integrated directly in a cable network without a switchgear assembly or a known circuit breaker being involved. The compact circuit breaker can be equipped with a large number of gas generators (small detonation capsules) for this purpose, each of them being arranged on the connection and disconnection side of the piston.

Variants are also possible with gas drive generators only being equipped on one side; in this case, springs or permanent magnet systems can, for example, additionally be used in order that the connection and/or disconnection positions can be maintained. The number of “mechanical” switching operations can be determined by the number of gas generators provided (if there is an option of manual switching, further mechanical switching operations are possible). If a device having a vacuum interrupter chamber pole or an SF6 breaker pole and the drive is cast into a plastic, such as a rubber-elastic material (for example silicone), a thermoplastic, a thermosetting plastic or casting resin (or in a suitable combination of these materials), the switching device can be integrated directly in a cable run.

Furthermore, the unit can be cast into a plastic cladding (1). The breaker has, in addition to the piston (8), the gas generators (6) and (10), which can serve for connecting and disconnecting the interrupter chamber (2) (vacuum or else a gas breaker). Explosive charges or pressure capsules, for example, can be used as the gas generators. For pressure compensation after a switching operation, the pressure control valves or flow resistance devices (capillary or sintered metals) (7) and (9) can be located on both sides. The current flow takes place through the unit in the manner shown (I). In the two end positions, the piston can be latched correspondingly mechanically and/or magnetically. A corresponding cavity can be provided for air to be compressed on the respective side or the gas, in which cavity an increase in pressure takes place temporarily until, for example, owing to the flow resistance devices, pressure compensation is again set at atmospheric pressure.

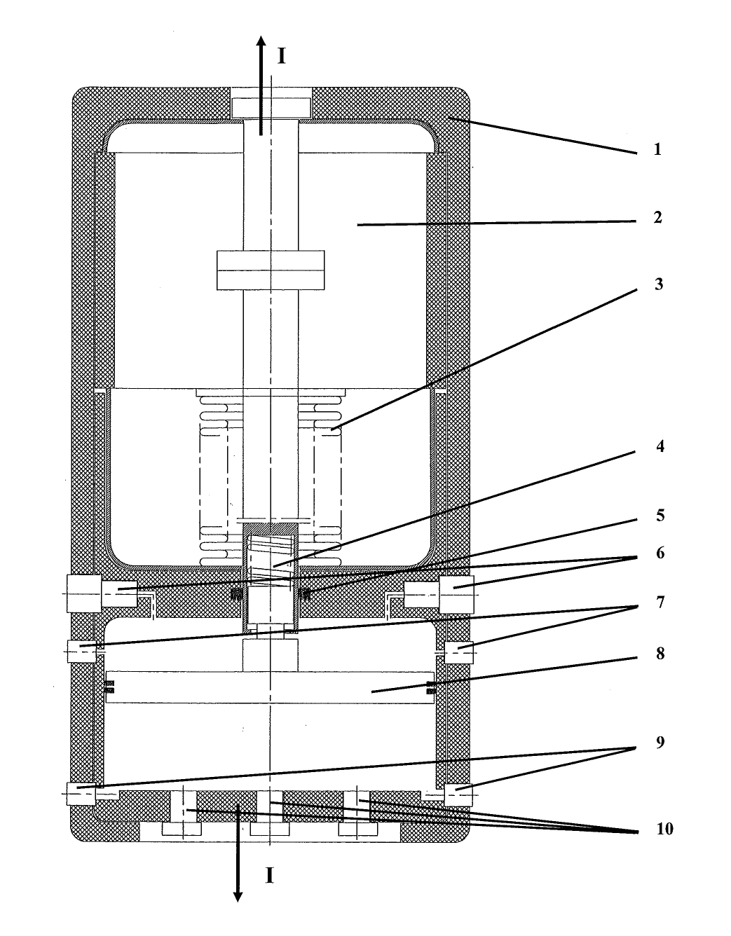

If, on one side, for example a spring (or hydraulics) for storing the energy for the connection or else disconnection is tensioned, gas generators can be used on one side. A large number of switching operations can be carried out by a large number of gas generators being used either on both sides or else only on one side. The gas generators can be ignited gradually from a controller. FIG. 1 shows a single-phase solution, but it is also possible to use a drive for, for example, three or more poles.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Plastic cladding
2 Vacuum interrupter
3 Bellows
4 Drive rod
5 Seal
6 Gas generator/microexplosive capsule
7 Sintered metal/gas flow resistance device-flow brake
8 Piston
9 Sintered metal/gas flow resistance device-flow brake
10 Gas generator/microexplosive capsule

What is claimed is:

1. A circuit breaker comprising:
a gas breaker drive for switching devices; and:
a piston/cylinder arrangement operated by a detonation capsule for disconnection at the breaker drive, wherein the piston/cylinder arrangement includes a plurality of detonation capsules for generating a limited number of connection and disconnection operations in the cylinder in each of two cylinder subareas separated by the piston.

2. The circuit breaker as claimed in claim 1, wherein the detonation capsules each comprise:
an ignitable explosive charge.

3. The circuit breaker as claimed in claim 1, wherein the detonation capsules comprise:
a compressed pressure medium.

4. The circuit breaker as claimed in claim 3, comprising:
a controllable valve for releasing the compressed pressure medium suddenly from the detonation capsule.

5. The circuit breaker as claimed in claim 3, comprising:
a controllable microexplosive charge for opening a closure of at least one detonation capsule.

6. The circuit breaker as claimed in claim 1, wherein the breaker is a vacuum interrupter chamber breaker.

7. The circuit breaker as claimed in claim 1, wherein the breaker is at least one of a single-phase breaker and a polyphase breaker arrangement.

8. The circuit breaker as claimed in claim 1, comprising:
pressure control valves arranged in a region of the cylinder which is applied with the detonation capsules, for deventilating to relieve pressure in an event of a pressure above a required actuation pressure.

9. The circuit breaker as claimed in claim 9, comprising:
at least one of a pressure valve, a sintered material element, and a flow resistance element for pressure relief.

10. The circuit breaker as claimed in claim 1, comprising:
a manually operable lever mechanism provided in redundant fashion, for a shutdown operation.

11. The circuit breaker as claimed in claim 1, comprising:
permanent magnets for holding contact elements in at least one of connection and disconnection end positions.

12. The circuit breaker as claimed in claim 1, comprising:
a vacuum interrupter chamber which, together with the piston/cylinder arrangement, is embedded in at least one of a thermosetting-plastic encapsulation, a rubber-elastic material, a plastic, and an injected combination thereof.

13. The circuit breaker as claimed in claim 1, comprising:
a female connector on each side for direct connection in a cable run.

14. The circuit breaker as claimed in claim 1, comprising:
a high-speed grounding system on at least on one connection side.
